(19) United States
(12) Patent Application Publication
(10) Pub. No.: US 2023/0049447 A1
(43) Pub. Date: Feb. 16, 2023

(54) SYSTEMS AND METHODS FOR FRONTHAUL OPTIMIZATION USING SOFTWARE DEFINED NETWORKING

(71) Applicant: CommScope Technologies LLC, Hickory, NC (US)

(72) Inventor: Harsha Hegde, Buffalo Grove, IL (US)

(73) Assignee: CommScope Technologies LLC, Hickory, NC (US)

(21) Appl. No.: 17/884,280

(22) Filed: Aug. 9, 2022

Related U.S. Application Data
(60) Provisional application No. 63/231,852, filed on Aug. 11, 2021.

(51) Int. Cl. H04W 40/02; H04L 45/00; H04W 4/06

(52) U.S. Cl. CPC H04W 40/02; H04L 45/66; H04W 4/06

(57) ABSTRACT

Systems and methods for fronthaul optimization using software defined networking are provided. In one example, a method includes receiving time period information and destination information for a time period from one or more base station entities (BSEs), each BSE configured to implement some functions for layer(s) of a wireless interface used to communicate with UEs. The method further includes determining a configuration of Ethernet switch(es) based on the destination information for the time period and topology information for the Ethernet switch(es). The Ethernet switch(es) are communicatively coupled to the BSE(s) and configured to: receive downlink fronthaul data from the BSE(s), be communicatively coupled to one or more RUs, and forward downlink fronthaul data from the one or more base station entities to the one or more RUs. The method further includes transmitting update(s) for forwarding rules to the Ethernet switch(es) based on the determined configuration for the Ethernet switch(es).

### CROSS-REFERENCE TO RELATED APPLICATIONS

This application claims priority to U.S. Provisional Application No. 63/231,852, filed on Aug. 11, 2021, and titled “SYSTEMS AND METHODS FOR FRONTHAUL OPTIMIZATION USING SOFTWARE DEFINED NETWORKING,” the contents of which are incorporated herein by reference in their entirety.

### BACKGROUND

Cloud-based virtualization of Fifth Generation (5G) base stations (also referred to as “gNodeBs” or “gNBs”) is widely promoted by standards organizations, wireless network operators, and wireless equipment vendors. Such an approach can help provide better high-availability and scalability solutions as well as addressing other issues in the network.

FIG. 1 is a block diagram illustrating a typical 5G network with a distributed gNB 100. In general, a distributed 5G gNB can be partitioned into different entities, each of which can be implemented in different ways. For example, each entity can be implemented as a physical network function (PNF) or a virtual network function (VNF) and in different locations within an operator's network (for example, in the operator's “edge cloud” or “central cloud”).

In the particular example shown in FIG. 1, a distributed 5G gNB 100 is partitioned into one or more central units (CUs) 102, one or more distributed units (DUs) 104, and one or more radio units (RUs) 106. In this example, each CU 102 is further partitioned into a central unit control-plane (CU-CP) 108 and one or more central unit user-planes (CU-UPs) 110 dealing with the gNB Packet Data Convergence Protocol (PDCP) and higher layers of functions of the respective control and user planes of the gNB 100. Each DU 104 is configured to implement the upper part of the physical layer through the radio link control layer of both the control-plane and user-plane of the gNB 100. In this example, each RU 106 is configured to implement the radio frequency (RF) interface and lower physical layer control-plane and user-plane functions of the gNB 100.

Each RU 106 is typically implemented as a physical network function (PNF) and is deployed in a physical location where radio coverage is to be provided. Each DU 104 is typically implemented as a virtual network function (VNF) and, as the name implies, is typically distributed and deployed in a distributed manner in the operator's edge cloud. Each CU-CP 108 and CU-UP 110 is typically implemented as a virtual network function (VNF) and, as the name implies, is typically centralized and deployed in the operator's central cloud. It should be understood that each DU 104 and/or each CU 102 can also be implemented as a PNF depending on circumstances.

A centralized or cloud radio access network (C-RAN) is one way to implement base station functionality. Typically, for each cell implemented by a C-RAN, a single baseband unit (BBU) interacts with multiple remote units (also referred to here as “RUs,” “radio points,” or “RPs”) in order to provide wireless service to various items of user equipment (UEs). The multiple remote units are typically located remotely from each other (that is, the multiple remote units are not co-located). The BBU is communicatively coupled to the remote units over a fronthaul network.

Downlink user data is scheduled for wireless transmission to each UE. When a C-RAN is used, the downlink user data for a UE can be wirelessly transmitted from a set of one or more remote units of the C-RAN. This set of remote units is also referred to here as the “simulcast zone” for the UE. The respective simulcast zone can vary from UE to UE. The corresponding downlink fronthaul data for each UE must be communicated from the BBU over the fronthaul network to each remote unit in that UE's simulcast zone.

In some embodiments, the C-RAN is configured to support frequency reuse. As used here, “downlink frequency reuse” refers to situations where separate downlink user data intended for different UEs is simultaneously wirelessly transmitted to the UEs using the same physical resource blocks (PRBs) for the same cell. For those PRBs where downlink frequency reuse is used, each of the multiple reuse UEs is served by a different subset of the RUs, where no RU is used to serve more than one UE for those reused PRBs. That is, for the reused PRBs, the simulcast zone for each of the multiple reuse UEs does not include any RU that is included in the simulcast zone of any of the other reuse UEs. Typically, these situations arise where the reuse UEs are sufficiently physically separated from each other so that the co-channel interference resulting from the different wireless downlink transmissions is sufficiently low (that is, where there is sufficient radio frequency (RF) isolation).

One way that downlink fronthaul data can be communicated over the fronthaul network from the BBU to the remote units in a UE's simulcast zone is to use broadcast transmission. A broadcast transmission causes the downlink fronthaul data to be transmitted over the fronthaul network to all of the remote units in the C-RAN in connection with that transmission. Some types of fronthaul networks (for example, switched Ethernet fronthaul networks) include native support for broadcast transmission that can reduce the amount of bandwidth used over at least some of the communications links in the fronthaul network (for example, in the Ethernet links used to couple the BBU to the rest of a switched Ethernet fronthaul network). Because a broadcast transmission causes the downlink fronthaul data to be transmitted to all of the remote units in the C-RAN, a BBU can use a single broadcast transmission in order to transmit a given packet (or other unit) of downlink fronthaul data to all of the remote units in the simulcast zone of a UE. Broadcast transmission is inefficient because all RUs receive packets containing downlink user data for all UEs, even if a given RU is not in the simulcast zone of a given UE. That is, each RU will receive packets containing downlink user data that the RU does not need. This can unnecessarily increase the bandwidth requirements for fronthaul Ethernet links that terminate at the RUs and possibly for Ethernet links in nearby switches.

Another way that downlink fronthaul data can be communicated over the fronthaul network from the BBU to the remote units in a UE's simulcast zone is to use unicast transmission. Each unicast transmission causes downlink fronthaul data to be transmitted over the fronthaul network to a single one of the remote units in the C-RAN in connection with that transmission. Because of this, in order to transmit a given packet (or other unit) of downlink fronthaul data over the fronthaul network from the BBU to each of the remote units in the simulcast zone of a UE, the BBU needs to make a separate unicast transmission for each such remote unit. However, using unicast transmission in this way can increase the amount of bandwidth used over at least some of the communications links in the fronthaul network (for example, in the Ethernet links used to couple the BBU to the rest of a switched Ethernet fronthaul network). This increase in bandwidth resulting from using unicast transmission typically scales by a factor approximately equal to the average simulcast zone size. This increase in bandwidth resulting from using unicast transmission is of special concern when downlink frequency reuse is used, since downlink fronthaul data for the multiple reuse UEs needs to be communicated over the fronthaul network from the BBU to all of the remote units in the simulcast zones of all of the multiple reuse UEs.

### SUMMARY

In one example, a system includes one or more base station entities. Each base station entity of the one or more base station entities is configured to implement at least some functions for one or more layers of a wireless interface used to communicate with user equipment. The system further includes one or more Ethernet switches communicatively coupled to the one or more base station entities. The one or more Ethernet switches are configured to receive downlink fronthaul data from the one or more base station entities, to be communicatively coupled to one or more radio units (RUs), and to forward downlink fronthaul data from the one or more base station entities to the one or more RUs. The system further includes at least one controller communicatively coupled to the one or more base station entities and the one or more Ethernet switches. The at least one controller is configured to receive time period information and destination information for a first time period from the one or more base station entities. The at least one controller is further configured to determine a configuration of the one or more Ethernet switches for the first time period based on the destination information and topology information for the one or more Ethernet switches and RUs. The at least one controller is further configured to transmit one or more updates for forwarding rules to the one or more Ethernet switches based on the determined configuration of the one or more Ethernet switches.

In another example, a method includes receiving time period information and destination information for a first time period from one or more base station entities. Each base station entity of the one or more base station entities is configured to implement at least some functions for one or more layers of a wireless interface used to communicate with user equipment. The method further includes determining a configuration of one or more Ethernet switches based on the destination information for the first time period and topology information for the one or more Ethernet switches. The one or more Ethernet switches are communicatively coupled to the one or more base station entities and configured to receive downlink fronthaul data from the one or more base station entities. The one or more Ethernet switches are further configured to be communicatively coupled to one or more radio units (RUs) and to forward downlink fronthaul data from the one or more base station entities to the one or more RUs. The method further includes transmitting one or more updates for forwarding rules to the one or more Ethernet switches based on the determined configuration for the one or more Ethernet switches.

### DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is a block diagram illustrating a 5G network with a distributed 5G gNB;

FIG. 2 is a block diagram of a fronthaul segment of a 5G network;

FIG. 3 is a flow diagram of an example method for modifying the fronthaul communication paths; and

FIG. 4 is a flow diagram of an example method for forwarding data packets.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be used and that logical, mechanical, and electrical changes may be made. The following detailed description is, therefore, not to be taken in a limiting sense.

For the switched Ethernet fronthaul networks included in a 5G network, downlink fronthaul data is carried between the base station entity (for example, DU) and the RUs. As discussed above, there are inefficiencies associated with using broadcast transmission or unicast transmission for transmitting the downlink fronthaul data to the UEs. Previous techniques for distributing downlink fronthaul data had significant overhead associated with the control messages required and did not scale well due to limits in the number of predefined multicast groups that could be established.

The systems and methods described herein improve bandwidth utilization for fronthaul switched Ethernet networks used to communicate fronthaul data packets to UEs in a cell compared to previous techniques. The systems and methods include selective configuration or reconfiguration of Ethernet switches in the switched Ethernet fronthaul network based on real-time needs of the network. In some examples, one or more Ethernet switches in the switched Ethernet fronthaul network are selectively configured using out-of-band control messaging by a controller. The controller is configured to determine a configuration for the one or more Ethernet switches in the switched Ethernet fronthaul network based on destination information for data packets from a base station entity and a topology of the switched Ethernet fronthaul network. The controller is also configured to transmit updates to the forwarding rules of the switches based on the determined configuration. In some examples, the controller is also configured to determine the changes required for the one or more Ethernet switches to implement the determined configuration and transmit updates to only particular Ethernet switches where changes are required.

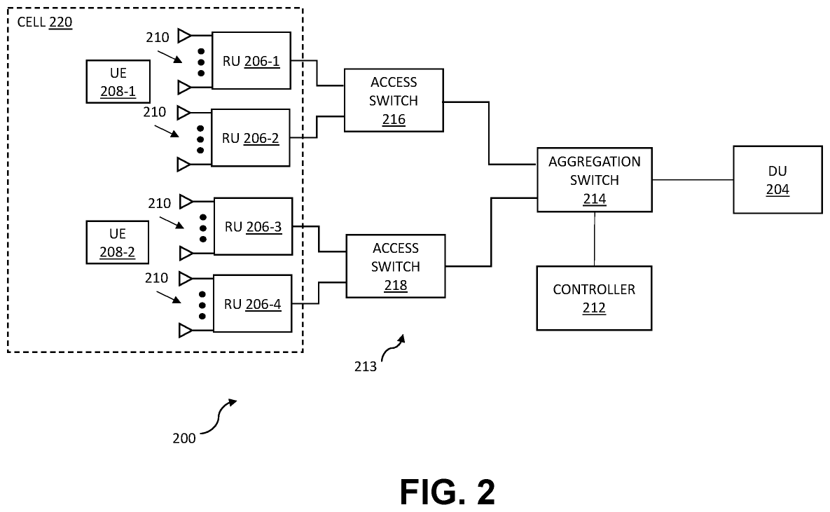

FIG. 2 is a block diagram illustrating one example of a segment of a 5G network 200 in which the techniques for configuring the fronthaul communication paths described herein can be implemented. In the particular example shown in FIG. 2, the 5G network 200 includes a distributed unit (DU) 204 and one or more radio units (RUs) 206. In this example, the 5G network 200 is configured so that each DU 204 is configured to serve one or more RUs 206. In the particular configuration shown in FIG. 2, the DU 204 serves four RUs 206. Although FIG. 2 (and the description set forth below more generally) is described in the context of a 5G embodiment in which each logical base station entity is partitioned into a CU, DUs 204, and RUs 206 and some physical-layer processing is performed in the DU 204 with the remaining physical-layer processing being performed in the RUs 206, it is to be understood that the techniques described here can be used with other wireless interfaces (for example, 4G LTE) and with other ways of implementing a base station entity (for example, using a conventional baseband band unit (BBU)/remote radio head (RRH) architecture. Accordingly, references to a CU, DU, or RU in this description and associated figures can also be considered to refer more generally to any entity (including, for example, any “base station” or “RAN” entity) implementing any of the functions or features described here as being implemented by a CU, DU, or RU.

Each RU 206 includes or is coupled to a respective set of one or more antennas 210 via which downlink RF signals are radiated to UEs 208 and via which uplink RF signals transmitted by UEs 208 are received. In one configuration (used, for example, in indoor deployments), each RU 206 is co-located with its respective set of antennas 210 and is remotely located from the DU 204 serving it as well as the other RUs 206. In another configuration (used, for example, in outdoor deployments), the respective sets of antennas 210 for multiple RUs 206 are deployed together in a sectorized configuration (for example, mounted at the top of a tower or mast), with each set of antennas serving a different sector. In such a sectorized configuration, the RUs 206 need not be co-located with the respective sets of antennas 210 and, for example, can be co-located together (for example, at the base of the tower or mast structure) and, possibly, co-located with its serving DU 204. Other configurations can be used.

The gNB that includes the components shown in FIG. 2 can be implemented using a scalable cloud environment in which resources used to instantiate each type of entity can be scaled horizontally (that is, by increasing or decreasing the number of physical computers or other physical devices) and vertically (that is, by increasing or decreasing the “power” (for example, by increasing the amount of processing and/or memory resources) of a given physical computer or other physical device). The scalable cloud environment can be implemented in various ways. For example, the scalable cloud environment can be implemented using hardware virtualization, operating system virtualization, and application virtualization (also referred to as containerization) as well as various combinations of two or more of the preceding. The scalable cloud environment can be implemented in other ways. For example, the scalable cloud environment is implemented in a distributed manner. That is, the scalable cloud environment is implemented as a distributed scalable cloud environment comprising at least one central cloud, at least one edge cloud, and at least one radio cloud.

In some examples, the DU 204 is implemented as a software virtualized entity that is executed in a scalable cloud environment on a cloud worker node under the control of the cloud native software executing on that cloud worker node. In such examples, the DU 204 is communicatively coupled to at least one CU-CP and at least one CU-UP, which can also be implemented as software virtualized entities, and are omitted from FIG. 2 for clarity.

In some examples, the DU 204 is implemented as a single virtualized entity executing on a single cloud worker node. In some examples, the at least one CU-CP and the at least one CU-UP can each be implemented as a single virtualized entity executing on the same cloud worker node or as a single virtualized entity executing on a different cloud worker node. However, it is to be understood that different configurations and examples can be implemented in other ways. For example, the CU can be implemented using multiple CU-UP VNFs and using multiple virtualized entities executing on one or more cloud worker nodes. In another example, multiple DUs 204 (using multiple virtualized entities executing on one or more cloud worker nodes) can be used to serve a cell, where each of the multiple DUs 204 serves a different set of RUs 206. Moreover, it is to be understood that the CU and DU can be implemented in the same cloud (for example, together in the radio cloud or in an edge cloud). Other configurations and examples can be implemented in other ways.

In the example shown in FIG. 2, each RU 206 is implemented as a physical network function (PNF) and is deployed in or near a physical location where radio coverage is to be provided. In the example shown in FIG. 2, the DU 204 is implemented with one or more DUs 204 and, as the name implies, is distributed and deployed in a distributed manner in the radio cloud. Each DU 204 is communicatively coupled to a CU-CP and CU-UP, which are centralized and can be deployed, for example, in the edge cloud or central cloud when virtualized. The DU 204 is configured to be coupled to the CU-CP and CU-UP(s) over a midhaul network (for example, a network that supports the Internet Protocol (IP)). In the example shown in FIG. 2, the DU 204 is communicatively coupled to each RU 206 served by the DU 204 using a switched Ethernet fronthaul network 213 (for example, a switched Ethernet network that supports the IP).

The particular configuration shown in FIG. 2 is only one example; other numbers of DUs 204 and RUs 206 can be used. Also, the number of RUs 206 served by each DU 204 can vary from DU to DU. Moreover, although the following embodiments are primarily described as being implemented for use to provide 5G NR service, it is to be understood the techniques described here can be used with other wireless interfaces (for example, fourth generation (4G) Long-Term Evolution (LTE) service) and references to “gNB” can be replaced with the more general term “base station” or “base station entity” and/or a term particular to the alternative wireless interfaces (for example, “enhanced NodeB” or “eNB”). Furthermore, it is also to be understood that 5G NR embodiments can be used in both standalone and non-standalone modes (or other modes developed in the future) and the following description is not intended to be limited to any particular mode. Also, unless explicitly indicated to the contrary, references to “layers” or a “layer” (for example, Layer 1, Layer 2, Layer 3, the Physical Layer, the MAC Layer, etc.) set forth herein refer to layers of the wireless interface (for example, 5G NR or 4G LTE) used for wireless communication between a base station and user equipment).

In general, the gNB that includes the components shown in FIG. 2 is configured to provide wireless service to various numbers of user equipment (UEs) 208 in a cell 220. For each UE 208 that is attached to the cell 220, the base station entity assigns a subset of the RUs 206 to that UE 208, where the RUs 206 in the subset are used to transmit to that UE 208. This subset of RUs 206 is referred to here as the “simulcast zone” for that UE 208.

The 5G network 200 that includes the components shown in FIG. 2 is configured to support frequency reuse. As noted above, “downlink frequency reuse” refers to situations where separate downlink user data intended for different UEs 208 is simultaneously wirelessly transmitted to the UEs 208 using the same physical resource blocks (PRBs) for the same cell 220. Such reuse UEs 208 are also referred to here as being “in reuse” with each other. For those PRBs where downlink frequency reuse is used, each of the multiple reuse UEs 208 is served by a different subset of the RUs 206, where no RU 206 is used to serve more than one UE 208 for those reused PRBs. That is, for the reused PRBs, the simulcast zone for each of the multiple reuse UEs 208 does not include any RU 206 that is included in the simulcast zone of any of the other reuse UEs 208. Typically, these situations arise where the reuse UEs 208 are sufficiently physically separated from each other so that the co-channel interference resulting from the different wireless downlink transmissions is sufficiently low (that is, where there is sufficient RF isolation).

In the examples described herein, the simulcast zone for each UE 208 is determined by the serving base station entity using a “signature vector” (SV) associated with that UE 208. In this example, a signature vector is determined for each UE 208. The signature vector is determined based on receive power measurements made at each of the RUs 206 serving the cell 220 for uplink transmissions from the UE 208.

When a UE 208 makes initial uplink transmissions (for example, Physical Random Access Channel (PRACH) transmissions), each RU 206 will receive those initial uplink transmissions and a signal reception metric indicative of the power level of the uplink transmissions received by that RU 206 is measured (or otherwise determined). One example of such a signal reception metric is a signal-to-noise-plus-interference ratio (SNIR). The signal reception metrics that are determined based on the PRACH transmissions are also referred to here as “PRACH metrics.”

Each signature vector is determined and updated over the course of that UE's connection to the cell 220 based on Sounding Reference Signals (SRSs) transmitted by the UE 208. A signal reception metric indicative of the power level of the SRS transmissions received by the RUs 206 (for example, a SNIR) is measured (or otherwise determined). The signal reception metrics that are determined based on the SRS transmissions are also referred to here as “SRS metrics.”

Each signature vector is a set of floating point SNIR values (or other metric), with each value or element corresponding to a RU 206 used to serve the cell 220.

The simulcast zone for a UE 208 contains the M RUs 206 with the best SV signal reception metrics, where M is the minimum number of RUs 206 required to achieve a specified SNIR. The simulcast zone for a UE 208 is determined by selecting those M RUs 206 based on the current SV.

In this example, multicast addressing is used for transporting downlink data over the fronthaul network 213. This is done by defining groups of RUs 206, where each group is assigned a unique multicast IP address. The Ethernet switches 214, 216, 218 in the fronthaul network 213 are configured to support forwarding downlink data packets using those multicast IP addresses. Each such group is also referred to here as a “multicast group.” The number of RUs 206 that are included in a multicast group is also referred to here as the “size” of the multicast group.

In the example shown in FIG. 2, the fronthaul network 213 is a switched Ethernet fronthaul network 213 that includes an aggregation Ethernet switch 214 communicatively coupled to the DU 204, and the aggregation Ethernet switch 214 is also communicatively coupled to a controller 212. In the example shown in FIG. 2, the switched Ethernet fronthaul network 213 also includes two access Ethernet switches 216, 218 communicatively coupled to the aggregation Ethernet switch 214. In the example shown in FIG. 2, the access Ethernet switch 216 is communicatively coupled to RUs 206-1, 206-2, and the access Ethernet switch 218 is communicatively coupled to the RUs 206-3, 206-4. While the switched Ethernet fronthaul network 213 shown in FIG. 2 includes a single aggregation Ethernet switch 214 and two access Ethernet switches 216, 218, it should be understood that this is an example and other numbers of access Ethernet switches (including one) and aggregation Ethernet switches (including zero) can be included depending on the network requirements. The controller 212 can be implemented in a cloud (for example, a radio cloud, an edge cloud, or a central cloud) or in one of the appliances in the radio access network (for example, in an Element Management System (EMS)).

The aggregation Ethernet switch 214 and the access Ethernet switches 216, 218 can be implemented as physical Ethernet switches or virtual Ethernet switches running in a cloud (for example, a radio cloud). In some examples, the aggregation Ethernet switch 214 and the access Ethernet switches 216, 218 are SDN capable and enabled Ethernet switches. In some such examples, the aggregation Ethernet switch 214 and the access Ethernet switches 216, 218 are OpenFlow capable and enabled Ethernet switches. In such examples, the aggregation Ethernet switch 214 and the access Ethernet switches 216, 218 are configured to distribute the downlink fronthaul data packets according to forwarding rules in respective flow tables and corresponding flow entries for each respective flow table.

For downlink fronthaul traffic, the aggregation Ethernet switch 214 is configured to receive downlink fronthaul data packets from the DU 204 and distribute the downlink fronthaul data packets to the RUs 206 via the access Ethernet switches 216, 218. In the example shown in FIG. 2, the aggregation Ethernet switch 214 is configured to distribute the downlink fronthaul data packets for the first UE 208-1 to the access Ethernet switch 216 and to distribute the downlink fronthaul data packets for the second UE 208-2 to the access Ethernet switch 218. In the example shown in FIG. 2, the access Ethernet switch 216 is configured to distribute the downlink fronthaul data packets for the first UE 208-1 to the RUs 206-1, 206-2, which are in a first multicast group, and the access Ethernet switch 218 is configured to distribute the downlink fronthaul data packets for the second UE 208-2 to the RUs 206-3, 206-4, which are in a second multicast group.

In some examples, the aggregation Ethernet switch 214 receives a single copy of each downlink fronthaul data packet from the DU 204 for each UE 208. In some examples, each copy is segmented into IP packets that have a destination address that is set to the address of the multicast group associated with that copy. The downlink fronthaul data packet is replicated and transmitted by the aggregation Ethernet switch 214 and access Ethernet switches 216, 218 as needed to distribute the downlink fronthaul data packets to the RUs 206 for the particular respective UEs 208. For example, with respect to FIG. 2, the aggregation Ethernet switch 214 is configured to receive a single copy of the downlink fronthaul data packets for the first UE 208-1, replicate the downlink fronthaul data packets, and transmit the replicated downlink fronthaul data packets to the access Ethernet switch 216. In this example, the access Ethernet switch 216 is configured to replicate the downlink fronthaul data packets received from the aggregation Ethernet switch 214 and transmit the replicated downlink fronthaul data packets to each of the RUs 206-1, 206-2, which form the multicast group serving the first UE 208-1. Similar replication/transmission is conducted by the aggregation Ethernet switch 214 and the access Ethernet switch 218 for providing the downlink fronthaul data packets to the RUs 206-3, 206-4, which form the multicast group serving the second UE 208-2.

During operation, the base station entity selects the multicast groups used to accommodate different requirements of the UEs 208 in proximity to the RUs 206, moving UEs 208, etc. for different time periods. Selecting the multicast groups can involve changing the RUs 206 serving a UE (for example, adding or removing a RU serving the UE and/or switching between the various multicast groups that are determined using the parameters and techniques described above). In order to implement changes to the multicast groups for a time period, the forwarding rules of the aggregation Ethernet switch 214 and/or access Ethernet switches 216, 218 in the switched Ethernet fronthaul network 213 are updated. In this context, the forwarding rules of the aggregation Ethernet switch 214 and/or access Ethernet switches 216, 218 in the switched Ethernet fronthaul network 213 establish what data packets are replicated by an Ethernet switch and where the replicated data packets are sent (for example, output ports of the Ethernet switch or RUs associated with output ports of the Ethernet switch). For SDN and OpenFlow capable and enabled switches, the forwarding rules can be included in flow tables and corresponding flow entries for each respective flow table.

In some examples, the controller 212 is a SDN controller, and the aggregation Ethernet switch 214 and the access Ethernet switches 216, 218 are configured using the controller 212. In some examples, the controller 212 is configured to receive multicast group configuration information from one or more base station entities (for example, DU 204) via out-of-band control messaging and provide the updates to the forwarding rules for the aggregation Ethernet switch 214 and/or the access Ethernet switches 216, 218 via out-of-band control messaging. In this context, the out-of-band control messaging is provided outside the control-plane of the 5G network 200, but the out-of-band control messaging is provided over the switched Ethernet fronthaul network 213. The out-of-band control messaging is provided from the one or more base station entities prior to transmission of the downlink fronthaul data packets to the aggregation Ethernet switch 214.

In some such examples, the one or more base station entities communicate with the controller 212 via a north-bound interface, and the controller 212 communicates with aggregation Ethernet switch 214 and access Ethernet switches 216, 218 via a south-bound interface. In the example shown in FIG. 2, the controller 212 is directly coupled to the aggregation Ethernet switch 214 and indirectly coupled to the access Ethernet switches 216, 218 via the aggregation Ethernet switch 214. It should be understood that other configurations could also be implemented. For example, the controller 212 can also be directly coupled to one or more of the access Ethernet switches 216, 218.

The multicast group configuration information is determined on a UE-by-UE basis and is applicable for a specific time period (for example, a transmission time interval (TTI)). In some examples, the multicast group configuration information includes time reference points or other generic time information for when the multicast groups are active and the destination addresses for downlink fronthaul data packets (for example, IP addresses of the RUs 206 in the multicast group) to be transmitted during the specific time period.

The controller 212 has access to topology information for at least a portion of the of the 5G network 200 (for example, the switched Ethernet fronthaul network 213 and RUs 206). In some examples, the topology information includes information regarding the IP addresses of the RUs 206 and a listing of the aggregation Ethernet switch(es) 214 and access Ethernet switch(es) 216, 218 in each respective downlink communication path between the DU 204 and each of the RUs 206.

In some examples, the controller 212 is configured to store destination information, topology information, and/or forwarding rules for one or more Ethernet switches in memory. The topology information is generally static, but the destination information and the forwarding rules vary depending on the particular time period and the multicast group configuration for the time period. In some examples, the topology information and/or the destination information is stored in a cache memory or other type of memory. In some examples, the forwarding rules for one or more previous time periods are stored in a cache memory or another type of memory in addition to (or instead of) the topology information and/or the destination information. The number of previous time periods stored in memory can be configurable and determined based on memory resources. In some examples, the controller 212 can store forwarding rules for ten or fewer previous time periods. It should be understood that a different number of previous time periods could be stored depending on the desired performance or requirements for the network.

The amount of cache memory or other type of memory used to store the information discussed above can be limited, so the controller 212 is configured to prioritize storing destination information and/or forwarding rules for one or more Ethernet switches associated with a simulcast zone with higher quality of service (QoS) requirements in some examples. For example, if the first simulcast zone served by the RUs 206-1, 206-2 has higher QoS requirements (for example, lower latency requirements) than the second simulcast zone served by the RUs 206-3, 206-4, the controller 212 can be configured to prioritize storage of the information related to first simulcast zone served by the RUs 206-1, 206-2 over the information related to the second simulcast zone served by the RUs 206-3, 206-4. By storing the information in cache memory in particular, the controller 212 can determine configurations of the one or more Ethernet switches and/or change information and provide updates to the one or more Ethernet switches more quickly for a simulcast zone with higher QoS requirements.

The controller 212 is configured to determine a configuration of the aggregation Ethernet switch 214 and/or the access Ethernet switches 216, 218 based on the multicast group configuration information and the topology information. In some examples, the controller 212 is configured to determine change information for the aggregation Ethernet switch 214 and/or the access Ethernet switches 216, 218 based on the multicast group configuration information and the topology information. In some examples, the controller 212 is configured to identify when the RUs 206 are assigned to a different multicast group compared to the current topology, identify the one or more of the access Ethernet switches 216, 218 and/or one or more aggregation Ethernet switch(es) 214 that need to be modified to implement the multicast group changes, and transmit updates to the forwarding rules for those access Ethernet switches 216, 218 and/or aggregation Ethernet switch(es) 214 to implement the multicast groups.

In some examples, the controller 212 only transmits updates to the Ethernet switches 214, 216, 218 when a change is needed to the forwarding rules of the Ethernet switches 214, 216, 218. In some examples, the controller 212 transmits the updates only to the access Ethernet switches 216, 218 and/or aggregation Ethernet switch(es) 214 that require changes for the particular time period that the multicast group configuration is applicable. In other examples, the controller 212 broadcasts the updates to all of the Ethernet switches 214, 216, 218 in the switched Ethernet fronthaul network 213, but only those Ethernet switches 214, 216, 218 requiring change process the updates.

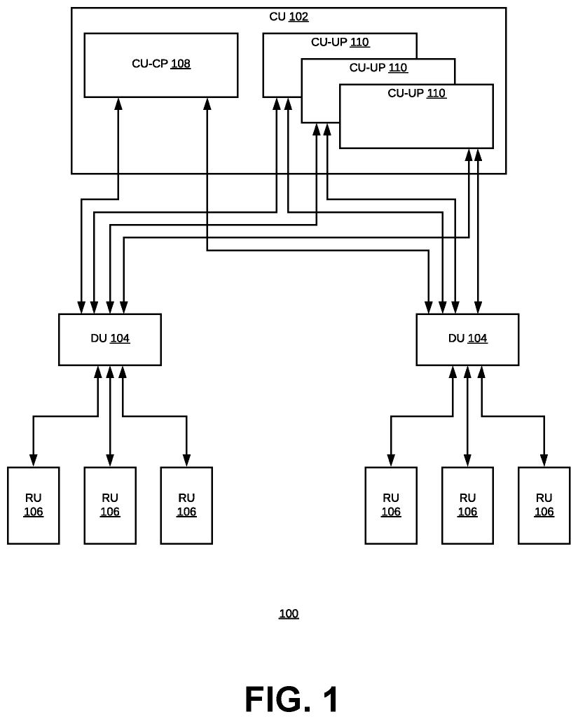

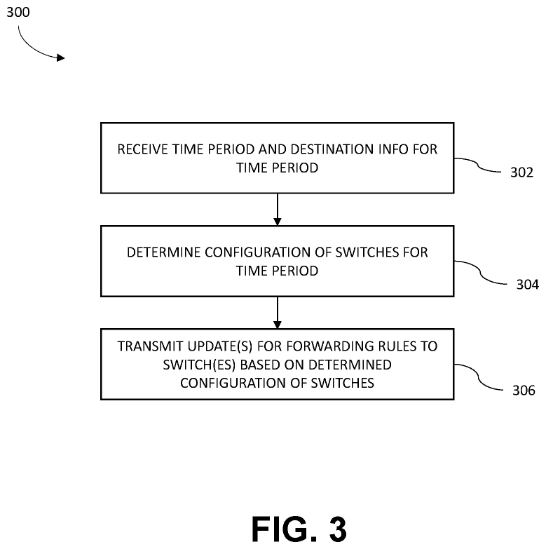

FIG. 3 is a flow diagram of an example method 300 for modifying the fronthaul communication paths. The common features discussed above with respect to the 5G networks in FIGS. 1-2 can include similar characteristics to those discussed with respect to method 300 and vice versa. In some examples, the method 300 is performed by a controller (for example, controller 212) in a 5G network.

The method 300 includes receiving time period information and destination information for a time period (block 302). In some examples, the time period information and destination information is sent from a base station entity (for example, DU 204) and received by a controller (for example, controller 212). The time period can be, for example, a future transmission time interval (TTI). In some examples, the time period information and destination information are determined based on a multicast group configuration generated by a base station entity (for example, DU 204). In some such examples, the multicast group configuration is determined based on SVs determined from power measurements made by the RUs or other metrics for the UEs in the cells of the RUs. The multicast group configuration can include information regarding scheduling and physical resource block (PRB) reuse across the different multicast groups of the 5G network and information regarding the RUs included in each multicast group.

The time period information can include time reference points or other generic time information for when the multicast group configuration is active. The destination information can include destination IP addresses for the RUs for each of the downlink fronthaul data packets to be transferred from the base station entity to the RUs via one or more Ethernet switches of a switched Ethernet fronthaul network.

The method 300 further includes determining a configuration of the one or more Ethernet switches for the time period (block 304). The configuration for the one or more Ethernet switches is determined based on the received destination information and topology information for the one or more Ethernet switches and RUs. The topology information can include the IP addresses of the RUs and a listing of the Ethernet switches (for example, aggregation Ethernet switches and/or access Ethernet switches) in each respective downlink communication paths between the base station entity and each RU. The configuration for the one or more Ethernet switches includes the forwarding rules to be implemented by each of the one or more Ethernet switches.

In some examples, determining a configuration of the one or more Ethernet switches also includes comparing the determined configuration to a previous configuration of the one or more Ethernet switches stored in memory to generate change information. In such examples, the change information includes the changes necessary to the previous configuration stored in memory in order to implement the determined configuration. The change information can include the modifications to forwarding rules for each of the Ethernet switches in order to implement the determined configuration.

The method 300 further includes transmitting one or more updates for forwarding rules to one or more Ethernet switches based on the determined configuration of the one or more Ethernet switches (block 306). In some examples, the updates transmitted to the one or more Ethernet switches include only the change information discussed above in order to reduce the bandwidth utilization to implement the configuration of the Ethernet switches. In some examples, the one or more updates for forwarding rules are only transmitted to Ethernet switches that need to be modified. In some examples, the one or more updates are providing via out-of-band control signals.

The networks and method 300 described above operate in real-time on a time period by time period basis (for example, a TTI-by-TTI basis). Typically, the base station entity, which controls the distribution of downlink fronthaul data packets and assignment of RUs to multicast groups, makes the determinations for the multicast group configuration several time periods in advances (for example, 4-5 TTIs in advance). The controller 212 and the Ethernet switches 214, 216, 218 in the switched Ethernet fronthaul network 213 can typically be reconfigured in time to implement the multicast group configuration from the base station entity. However, there are circumstances where the Ethernet switches 214, 216, 218 may not be reconfigured in time and this needs to be accommodated to ensure that the downlink fronthaul data packets reach the intended destination (for example, the UEs 208 in the cell 220).

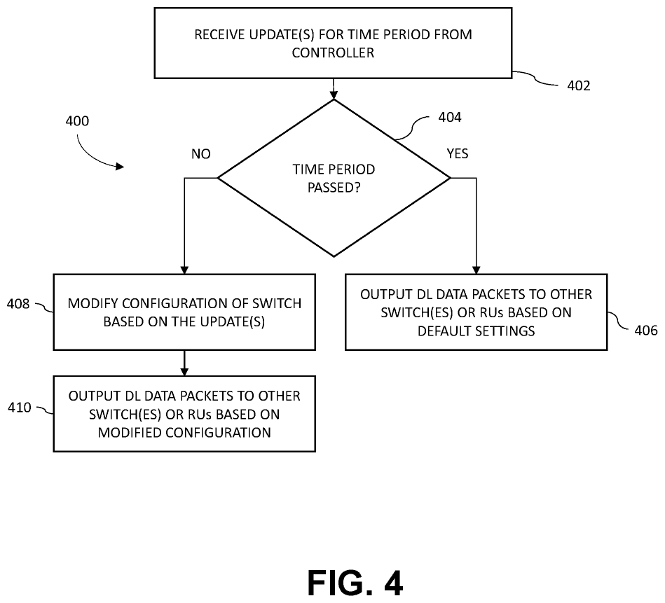

FIG. 4 is a flow diagram of an example method 400 for forwarding data packets in a switched Ethernet fronthaul network. The common features discussed above with respect to the 5G networks in FIGS. 1-2 can include similar characteristics to those discussed with respect to method 400 and vice versa. In some examples, the method 400 is performed by an Ethernet switch (for example, an aggregation Ethernet switch or access Ethernet switch) in the switched Ethernet fronthaul network.

The method 400 begins with receiving one or more updates to a configuration for an Ethernet switch for a particular time period (block 402). In some examples, the one or more updates are generated using the method 300 described above with respect to FIG. 3. In other examples, the one or more updates are generated in other ways.

The method 400 includes determining whether the particular time period has passed (block 404). In some examples, determining whether the particular time period has passed includes comparing a current time (for example, from a reference clock of the Ethernet switch) to an end time for the particular time period.

When it is determined that the time period has passed, the method 400 proceeds with outputting downlink data packets to another Ethernet switch or the one or more RUs based on default settings (block 406). In some examples, the default settings include forwarding rules to broadcast the downlink data packets to all Ethernet switches (for an aggregation Ethernet switch) or all RUs (for an access Ethernet switch) communicatively coupled to the respective Ethernet switch of the one or more Ethernet switches. In other examples, the default settings include forwarding rules to multicast the downlink data packets to less than all RUs communicatively coupled to the respective Ethernet switch of the one or more Ethernet switches. Each Ethernet switch can be individually configured with specific default settings, which are used as a backup in case the updates are not transmitted to the one or more Ethernet switches in a timely manner.

When it is determined that the time period has not passed, the method 400 proceeds with modifying the configuration of the Ethernet switch based on the updates (block 408). In some examples, modifying the configuration of the Ethernet switch includes modifying the forwarding rules for the Ethernet switch. In some such examples, modifying the forwarding rules includes modifying a flow table and/or a flow entry of the Ethernet switch.

The method 400 proceeds with outputting downlink data packets to other switch(es) or the one or more RUs based on the modified configuration (block 410). In some examples, outputting downlink data packets to other switch(es) (for an aggregation Ethernet switch) or one or more RUs (for an access Ethernet switch) based on the modified configuration includes outputting downlink data packets to only the Ethernet switches or RUs in the downlink communication path for the multicast group from which the downlink data packets are to be transmitted.

Since the downlink fronthaul data packets are provided to only the RUs and Ethernet switches required to distribute the downlink fronthaul data packets to the UEs served by various multicast groups of RUs, the bandwidth utilization for the switched Ethernet fronthaul network is improved compared to previous techniques for unicast, broadcast, and multicast implementations. Also, even if frequency reuse is not needed in the cell, transmitting from only the needed RUs using the techniques described herein reduces overall interference in the cell.

Other examples are implemented in other ways.

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random-access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs).

### Example Embodiments

Example 1 includes a system, comprising: one or more base station entities, wherein each base station entity of the one or more base station entities is configured to implement at least some functions for one or more layers of a wireless interface used to communicate with user equipment; one or more Ethernet switches communicatively coupled to the one or more base station entities, wherein the one or more Ethernet switches are configured to receive downlink fronthaul data from the one or more base station entities, wherein the one or more Ethernet switches are configured to be communicatively coupled to one or more radio units (RUs) and to forward downlink fronthaul data from the one or more base station entities to the one or more RUs; at least one controller communicatively coupled to the one or more base station entities and the one or more Ethernet switches, wherein the at least one controller is configured to: receive time period information and destination information for a first time period from the one or more base station entities; determine a configuration of the one or more Ethernet switches for the first time period based on the destination information and topology information for the one or more Ethernet switches and RUs; and transmit one or more updates for forwarding rules to the one or more Ethernet switches based on the determined configuration of the one or more Ethernet switches.

Example 2 includes the system of Example 1, wherein the at least one controller is configured to store destination information and/or forwarding rules for a previous time period in a memory.

Example 3 includes the system of any of Examples 1-2, wherein the at least one controller is configured to prioritize storage of forwarding rules for one or more Ethernet switches associated with a simulcast zone of RUs with higher quality of service requirements in a memory.

Example 4 includes the system of any of Examples 1-3, wherein the one or more base station entities includes a distributed unit, wherein the distributed unit is configured to determine the time period information and the destination information for the first time period.

Example 5 includes the system of any of Examples 1-4, wherein the at least one controller is further configured to: determine change information based on the determined configuration of the one or more Ethernet switches for the first time period and a previous configuration of the one or more Ethernet switches stored in memory, wherein the change information indicates differences between the determined configuration of the one or more Ethernet switches for the first time period and the previous configuration of the one or more Ethernet switches; and transmit the one or more updates for forwarding rules to only Ethernet switches having a different configuration in the determined configuration compared to the previous configuration stored in memory.

Example 6 includes the system of any of Examples 1-5, further comprising: the one or more RUs, wherein each RU of the one or more RUs is communicatively coupled to the one or more base station entities via the one or more Ethernet switches, wherein each RU of the one or more RUs is associated with a respective set of one or more antennas via which downlink radio frequency signals are radiated to at least some of the user equipment and via which uplink radio frequency signals transmitted by at least some of the user equipment are received.

Example 7 includes the system of Example 6, wherein the one or more RUs includes a plurality of RUs, wherein the one or more Ethernet switches include: at least one aggregation Ethernet switch communicatively coupled to the one or more base station entities and the at least one controller; and a plurality of access Ethernet switches communicatively coupled to the at least one aggregation Ethernet switch, wherein each access Ethernet switch of the plurality of access Ethernet switches is communicatively coupled to at least one of RU of the plurality of RUs.

Example 8 includes the system of any of Examples 1-7, wherein a respective Ethernet switch of the one or more Ethernet switches is further configured to: determine whether the first time period has passed; in response to a determination that the first time period has passed, forward downlink fronthaul data according to default settings; and in response to a determination that the first time period has not passed, forward downlink fronthaul data as indicated by the one or more updates for forwarding rules for the first time period.

Example 9 includes the system of Example 8, wherein the default settings include broadcasting the downlink fronthaul data to Ethernet switches or RUs communicatively coupled to the respective Ethernet switch of the one or more Ethernet switches.

Example 10 includes the system of Example 8, wherein the default settings include multicasting the downlink fronthaul data to less than all Ethernet switches or RUs communicatively coupled to the respective Ethernet switch of the one or more Ethernet switches.

Example 11 includes the system of any of Examples 1-10, wherein the system includes a scalable cloud environment configured to implement the one or more Ethernet switches and/or the at least one controller.

Example 12 includes a method, comprising: receiving time period information and destination information for a first time period from one or more base station entities, wherein each base station entity of the one or more base station entities is configured to implement at least some functions for one or more layers of a wireless interface used to communicate with user equipment; determining a configuration of one or more Ethernet switches based on the destination information for the first time period and topology information for the one or more Ethernet switches, wherein the one or more Ethernet switches are communicatively coupled to the one or more base station entities, wherein the one or more Ethernet switches are configured to receive downlink fronthaul data from the one or more base station entities, wherein the one or more Ethernet switches are configured to be communicatively coupled to one or more radio units (RUs) and to forward downlink fronthaul data from the one or more base station entities to the one or more RUs; and transmitting one or more updates for forwarding rules to the one or more Ethernet switches based on the determined configuration for the one or more Ethernet switches.

Example 13 includes the method of Example 12, further comprising storing destination information and/or forwarding rules for a previous time period in a memory.

Example 14 includes the method of any of Examples 12-13, further comprising prioritizing storage of forwarding rules for one or more Ethernet switches associated with a simulcast zone of RUs with higher quality of service requirements in a memory.

Example 15 includes the method of any of Examples 12-14, wherein the one or more base station entities includes a distributed unit, the method further comprising determining the time period information and the destination information for the first time period with the distributed unit.

Example 16 includes the method of any of Examples 12-15, wherein the one or more RUs includes a plurality of RUs, wherein the one or more Ethernet switches include: at least one aggregation Ethernet switch communicatively coupled to the one or more base station entities; and a plurality of access Ethernet switches communicatively coupled to the at least one aggregation Ethernet switch, wherein each access Ethernet switch of the plurality of access Ethernet switches is communicatively coupled to one or more RUs of the plurality of RUs.

Example 17 includes the method of any of Examples 12-16, further comprising: determining whether the first time period has passed; in response to a determination that the first time period has passed, forwarding downlink fronthaul data to the one or more RUs according to default settings; and in response to a determination that the first time period has not passed, forwarding downlink fronthaul data to the one or more RUs as indicated by the one or more updates for forwarding rules for the first time period.

Example 18 includes the method of Example 17, wherein forwarding downlink fronthaul data to the one or more RUs according to default settings includes broadcasting downlink fronthaul data from a first Ethernet switch of the one or more Ethernet switches to all RUs communicatively coupled to the first Ethernet switch of the one or more Ethernet switches.

Example 19 includes the method of any of Examples 17-18, wherein forwarding downlink fronthaul data to the one or more RUs according to default settings includes multicasting the downlink fronthaul data from a first Ethernet switch of the one or more Ethernet switches to less than all RUs communicatively coupled to the first Ethernet switch of the one or more Ethernet switches.

Example 20 includes the method of any of Examples 12-19, further comprising: determining specific Ethernet switches in a communication path for a simulcast zone for the first time period based on a known topology of the one or more Ethernet switches and one or more RUs and the destination information; determining change information for the specific Ethernet switches based on the determined configuration of the one or more Ethernet switches for the first time period and a previous configuration of the one or more Ethernet switches stored in memory, wherein the change information indicates differences between the determined configuration of the one or more Ethernet switches for the first time period and the previous configuration of the one or more Ethernet switches; and transmitting one or more updates for forwarding rules for the first time period to only the specific Ethernet switches having a different configuration in the determined configuration of the one or more Ethernet switches for the first time period compared to the previous configuration stored in memory.

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

What is claimed is:

1. A system, comprising:
one or more base station entities, wherein each base station entity of the one or more base station entities is configured to implement at least some functions for one or more layers of a wireless interface used to communicate with user equipment;
one or more Ethernet switches communicatively coupled to the one or more base station entities, wherein the one or more Ethernet switches are configured to receive downlink fronthaul data from the one or more base station entities, wherein the one or more Ethernet switches are configured to be communicatively coupled to one or more radio units (RUs) and to forward downlink fronthaul data from the one or more base station entities to the one or more RUs;
at least one controller communicatively coupled to the one or more base station entities and the one or more Ethernet switches, wherein the at least one controller is configured to:
receive time period information and destination information for a first time period from the one or more base station entities;
determine a configuration of the one or more Ethernet switches for the first time period based on the destination information and topology information for the one or more Ethernet switches and RUs; and
transmit one or more updates for forwarding rules to the one or more Ethernet switches based on the determined configuration of the one or more Ethernet switches.

2. The system of claim 1, wherein the at least one controller is configured to store destination information and/or forwarding rules for a previous time period in a memory.

3. The system of claim 1, wherein the at least one controller is configured to prioritize storage of forwarding rules for one or more Ethernet switches associated with a simulcast zone of RUs with higher quality of service requirements in a memory.

4. The system of claim 1, wherein the one or more base station entities includes a distributed unit, wherein the distributed unit is configured to determine the time period information and the destination information for the first time period.

5. The system of claim 1, wherein the at least one controller is further configured to:
determine change information based on the determined configuration of the one or more Ethernet switches for the first time period and a previous configuration of the one or more Ethernet switches stored in memory, wherein the change information indicates differences between the determined configuration of the one or more Ethernet switches for the first time period and the previous configuration of the one or more Ethernet switches; and
transmit the one or more updates for forwarding rules to only Ethernet switches having a different configuration in the determined configuration compared to the previous configuration stored in memory.

6. The system of claim 1, further comprising:
the one or more RUs, wherein each RU of the one or more RUs is communicatively coupled to the one or more base station entities via the one or more Ethernet switches, wherein each RU of the one or more RUs is associated with a respective set of one or more antennas via which downlink radio frequency signals are radiated to at least some of the user equipment and via which uplink radio frequency signals transmitted by at least some of the user equipment are received.

7. The system of claim 6, wherein the one or more RUs includes a plurality of RUs, wherein the one or more Ethernet switches include:
at least one aggregation Ethernet switch communicatively coupled to the one or more base station entities and the at least one controller; and
a plurality of access Ethernet switches communicatively coupled to the at least one aggregation Ethernet switch, wherein each access Ethernet switch of the plurality of access Ethernet switches is communicatively coupled to at least one of RU of the plurality of RUs.

8. The system of claim 1, wherein a respective Ethernet switch of the one or more Ethernet switches is further configured to:
determine whether the first time period has passed;
in response to a determination that the first time period has passed, forward downlink fronthaul data according to default settings; and
in response to a determination that the first time period has not passed, forward downlink fronthaul data as indicated by the one or more updates for forwarding rules for the first time period.

9. The system of claim 8, wherein the default settings include broadcasting the downlink fronthaul data to Ethernet switches or RUs communicatively coupled to the respective Ethernet switch of the one or more Ethernet switches.

10. The system of claim 8, wherein the default settings include multicasting the downlink fronthaul data to less than all Ethernet switches or RUs communicatively coupled to the respective Ethernet switch of the one or more Ethernet switches.

11. The system of claim 1, wherein the system includes a scalable cloud environment configured to implement the one or more Ethernet switches and/or the at least one controller.

12. A method, comprising:
receiving time period information and destination information for a first time period from one or more base station entities, wherein each base station entity of the one or more base station entities is configured to implement at least some functions for one or more layers of a wireless interface used to communicate with user equipment;
determining a configuration of one or more Ethernet switches based on the destination information for the first time period and topology information for the one or more Ethernet switches, wherein the one or more Ethernet switches are communicatively coupled to the one or more base station entities, wherein the one or more Ethernet switches are configured to receive downlink fronthaul data from the one or more base station entities, wherein the one or more Ethernet switches are configured to be communicatively coupled to one or more radio units (RUs) and to forward downlink fronthaul data from the one or more base station entities to the one or more RUs; and
transmitting one or more updates for forwarding rules to the one or more Ethernet switches based on the determined configuration for the one or more Ethernet switches.

13. The method of claim 12, further comprising storing destination information and/or forwarding rules for a previous time period in a memory.

14. The method of claim 12, further comprising prioritizing storage of forwarding rules for one or more Ethernet switches associated with a simulcast zone of RUs with higher quality of service requirements in a memory.

15. The method of claim 12, wherein the one or more base station entities includes a distributed unit, the method further comprising determining the time period information and the destination information for the first time period with the distributed unit.

16. The method of claim 12, wherein the one or more RUs includes a plurality of RUs, wherein the one or more Ethernet switches include:
at least one aggregation Ethernet switch communicatively coupled to the one or more base station entities; and
a plurality of access Ethernet switches communicatively coupled to the at least one aggregation Ethernet switch, wherein each access Ethernet switch of the plurality of access Ethernet switches is communicatively coupled to one or more RUs of the plurality of RUs.

17. The method of claim 12, further comprising:
determining whether the first time period has passed;
in response to a determination that the first time period has passed, forwarding downlink fronthaul data to the one or more RUs according to default settings; and
in response to a determination that the first time period has not passed, forwarding downlink fronthaul data to the one or more RUs as indicated by the one or more updates for forwarding rules for the first time period.

18. The method of claim 17, wherein forwarding downlink fronthaul data to the one or more RUs according to default settings includes broadcasting downlink fronthaul data from a first Ethernet switch of the one or more Ethernet switches to all RUs communicatively coupled to the first Ethernet switch of the one or more Ethernet switches.

19. The method of claim 17, wherein forwarding downlink fronthaul data to the one or more RUs according to default settings includes multicasting the downlink fronthaul data from a first Ethernet switch of the one or more Ethernet switches to less than all RUs communicatively coupled to the first Ethernet switch of the one or more Ethernet switches.

20. The method of claim 12, further comprising:
determining specific Ethernet switches in a communication path for a simulcast zone for the first time period based on a known topology of the one or more Ethernet switches and one or more RUs and the destination information;
determining change information for the specific Ethernet switches based on the determined configuration of the one or more Ethernet switches for the first time period and a previous configuration of the one or more Ethernet switches stored in memory, wherein the change information indicates differences between the determined configuration of the one or more Ethernet switches for the first time period and the previous configuration of the one or more Ethernet switches; and
transmitting one or more updates for forwarding rules for the first time period to only the specific Ethernet switches having a different configuration in the determined configuration of the one or more Ethernet switches for the first time period compared to the previous configuration stored in memory.
